(19) United States
(12) Patent Application Publication
(10) Pub. No.: US 2016/0135922 A1
(43) Pub. Date: May 19, 2016

(54) GLOTTO-MANDIBULAR ARCHES DEVICE FOR TMJ DISEASE

(71) Applicant: Alessandro RAMPELLO, Rome (IT)

(72) Inventor: Alessandro RAMPELLO, Rome (IT)

(21) Appl. No.: 14/942,211

(22) Filed: Nov. 16, 2015

(30) Foreign Application Priority Data
Nov. 17, 2014 (IT) RM2014A000673

(51) Int. Cl. A61C 5/00; A61C 5/14

(52) U.S. Cl. CPC A61C 5/007; A61C 5/14

(57) ABSTRACT

The present disclosure relates to glotto-mandibular arches devices for the relaxation and rebalancing of the muscles and skin tissues of the face and for the therapy of TMJ dysfunction and skull-cervico-mandibular disorders, by means of the change of the posture of the tongue and a different positioning of the jaw and condyles producing a change in force vectors of masticatory and skull-cervical-mandibular muscles.

### CROSS REFERENCE TO RELATED APPLICATIONS

The present application claims priority to Italian patent application no. RM2014A000673 filed on Nov. 17, 2014. The entire disclosure of the foregoing application is hereby incorporated herein by reference

### FIELD

The present disclosure relates to glotto-mandibular arches devices for the relaxation and rebalancing of the muscles and skin tissues of the face and for the therapy of TMJ dysfunction and skull-cervico-mandibular disorders.

### BACKGROUND

At the international level, countless universal devices to be placed in the mouth have been proposed and all are somewhat structured to intervene only in the dental arches. To date, in fact, the Inventor does not know a universal device to be inserted in the mouth, which would also be adapted to re-educate the tongue position and to harmonize all the components of the stomatognathic and cervical spine. Positional rehabilitation of the tongue has, in fact, beneficial effects on bruxing and clenching of the teeth, caused by stress or dysfunctions, and in a reflected way prevents and treats joints disorders of the TMJ (“Temporo-Mandibular Joint”) and the postural disorders of the various metameres of the spine.

Document WO2010/035303 of Rampello discloses a device that spaces away the teeth in a passive way not to make them come into contact, without changing the lengths of the muscles and the skull-mandibular levers. It has no rehabilitative function and therefore does not cure the underlying problem of bruxing.

Document U.S. Pat. No. 4,304,227 A of Samelson et al. discloses a device that forces the tongue to enter inside a cylinder 24 (FIGS. 2 and 3) and this tends to obstruct the mouth breathing to promote nasal breathing. This device is used basically for night snoring and its structure also provides a portion external to the mouth and lips (10 and 12 in FIG. 1). Again, it does not act on the cause of bruxism, changing the lengths of the muscles and craniomandibular levers, but spaces apart only the teeth and therefore plays only a protection action against wear of the teeth and an action to improve the night snoring.

Document US2012/103345 of Gay at al. discloses a device requiring the tongue to remain low under a bridge 4 (FIG. 1) to leave a free space above the tongue in order to make air pass through during breathing. Again, this device is basically used for night snoring and sleep apnea. It does not act on bruxism, changing craniomandibular levers and lengths of muscles, but spaces away the teeth and plays an opposition action and protection action aiming more to improve the night snoring.

Other general reference devices are those disclosed in documents US 2008/295850 A1, WO2014/018105.

The object of the present invention is therefore to provide a device with innovative elements, which allow a new vision of therapeutic approach and harmonized rebalancing of all the components of the stomatognathic system, basically proposing a functional positional re-education stimulus, even by a different orientation of the load vectors of muscle forces.

### BRIEF DESCRIPTION OF THE DRAWINGS

The invention will now be described by way of illustration but not by way of limitation, with particular reference to the drawings of the accompanying figures, in which:

FIG. 1 shows a front perspective view rotated by ¾ of a first device according to an aspect of the invention;

FIG. 2 shows a postero-superior perspective view, rotated by ¾, of the device according to FIG. 1;

FIG. 3 shows a front perspective view rotated by ¾ of a device according to an aspect of the invention, with the two symmetrical vertical side genial shields “5d” and “5s”;

FIG. 4 shows a front perspective view rotated by ¾ of the device according to the invention with two symmetrical vertical side shields “5d” and “5s” and a vestibular band “6”;

FIG. 5 shows a postero-superior perspective view, rotated by ¾, of the device according to an aspect of the invention with two symmetrical vertical side genial shields “5d” and “5s”, a vestibular band “6” and a circular button “7”, as well as two main planes of symmetry;

FIG. 6 shows a postero-superior perspective view of the device according to the invention in a custom variation with ball hooks “8d” and “8s” as retention elements instead of the genial side shields “5d” and “5s”;

FIG. 7 shows a postero-superior perspective view rotated by ¾ of the device according to an aspect of the invention with two symmetrical genial shields “5d” and “5s”, a vestibular band “6”, a circular button “7” and with reduced occlusal plans “3d” and “3s”;

FIG. 8 shows a bottom view of the device of the invention in a variation with a plate “9”, which is personalized on plaster casts and with the lingual ring that is structured as modular element to be connected to and disconnected from said plate;

FIG. 9 shows a postero-superior view of the device according to an aspect of the invention in a custom variation with extended plate with higher wings “4d” and “4s”, external vertical genial shields “5d” and “5s” extended in continuation with wider front band “6”;

FIG. 10 shows a side perspective view rotated by ¾ of the device according to an aspect of the invention in a custom variation with extended plate having higher wings “4d” and “4s”, external vertical genial shields “5d” and “5s” which are extended without solution of continuity to a wider front band “6”;

FIG. 11 shows the device of FIG. 5 as seen from a side, parallel to the sagittal plane;

FIG. 12 shows the device of FIG. 5 in the sagittal section; and

FIG. 13 shows the device of FIG. 5 as seen from above.

### DETAILED DESCRIPTION

The present invention relates to a device in the form of a ring which surrounds the tongue and is joined to various structural and functional surfaces.

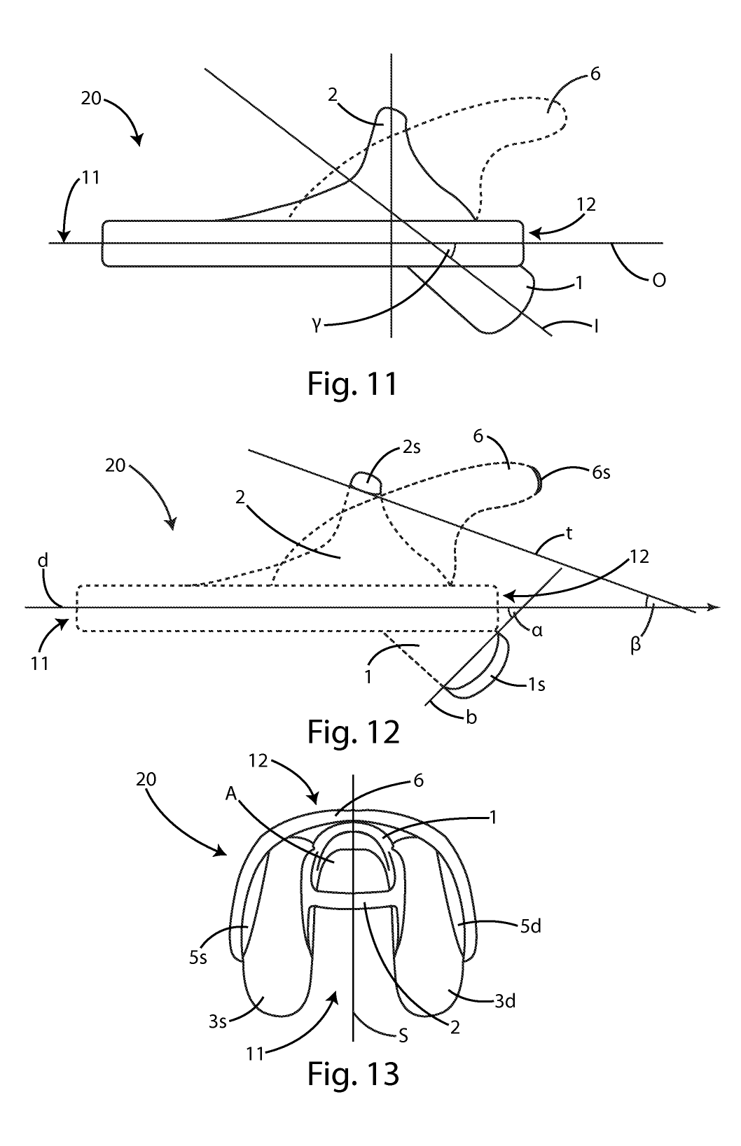

Referring to the figures, the lingual ring is formed by two arcs: the lower arc “1” and the upper arch “2”, which are connected to a left surface 3s and a right surface 3d (which in this representation are trapezoidal with symmetrical left and right rounded corners), which lie on a single horizontal plane O, as shown in FIGS. 5, 11 (this feature may be common to all the aspects of the invention). In the following description, reference is made to a lower arc and an upper arc. However, it should be understood that the arcs may be, in both cases, multiple. The arches 1, 2 and the surfaces 3s, 3d form an opening in which the tongue is to be inserted.

Referring now to FIG. 5, it is seen that there is a plane of symmetry S, which in use coincides with the sagittal plane of the body, which is perpendicular to said horizontal plane O. The intersection of these two planes is a line d that defines also a direction of extension of the device. The two surfaces 3s and 3d are mirror-like (specular) surfaces with respect to the plane S. In general, the other parts of the device are mirror-like with respect to this plane of symmetry, as well.

The device has a front side 12 and a rear side 11. The rear side 11 is the one which in use is positioned in the back of the mouth, whereas the front side 12 is the one which in use is positioned in front of the incisors. By this, the direction of extension “d” as proceeding from the rear side 11 to the front side 12 is also defined. This direction is clearly indicated in FIG. 12 and is common to all the devices according to the various aspects of the invention.

Referring now to FIGS. 11 to 13, the positioning of the upper and lower arches is illustrated. From FIG. 11, it is seen that the upper arc 2 extends above the horizontal plane O, i.e., in use, towards the palate. On the contrary, the lower arc 1 extends below the horizontal plane O, i.e., in use, towards the floor of the mouth. The lower arc 1 is inclined with respect to the horizontal plane O. Indeed, it lies on an inclined plane I which form, along the direction d, an angle γ with the horizontal plane O, which is an acute angle, i.e. less than 90°.

The upper arch 2 can be inclined in various ways or be substantially perpendicular to the horizontal plane O. What is important is that the external and internal surface of said upper arc are inclined in an appropriate manner. More in detail, with reference to FIG. 12, it is seen that the inner surface of the section 2s of the upper arch 2 on the sagittal plane S has an inclination in the direction of extension d equal to an angle β that is an acute angle. The upper arch 2 is shown as palatal or retro-incisal arch, and leads to the positional re-education of the tongue-bone-hyoid complex by constituting a reference point. It extends so as to surround the palate, or behind the upper front tooth group.

Similarly, the inner surface of the section 1s on the sagittal plane S of the lower arch 1 is inclined with respect to said direction “d” by an acute angle α. This leads to the three-dimensional positional re-education of the whole tongue-hyoid-bone, peripharyngeal muscles, jaw and condyles complex. The arc extends downwardly in the front vestibule of the floor of the mouth and obliges the tongue to assume a higher position, it obliges the lower incisors and the lower jaw in a posture more advanced than the usual one and, as a consequence, it compels condyles, masticatory and back-of-head muscles, in a protruded position.

In this way, the lingual ring has an overall internal shape that is funnel-shaped, so that the tongue is pushed upwards (palate) with major consequences for the cure of certain disorders.

Therefore, the device with the characteristics just described, by the lingual ring, provides positional rehabilitation of the tongue and of all the components of the stomatognathic apparatus. This differentiates it from other universal devices of the prior art, which instead tend to space away the only dental arches. The re-education of the tongue has in fact beneficial effects on all components of the stomatognathic system and spine in order to facilitate the resolution of symptoms and occlusal-joint dysfunctions, such as: cervical, headaches, soreness of the column, the clenching-grinding of the teeth and dysfunctions of jaw joints, with solutions of orthodontic, speech, night snoring, sleep apnea, tropism of mimic muscles and skin face tissues problems.

In particular, the present device is a positional rehabilitator, harmonizing the active rachis and not a simple passive bearing which spaces away the teeth. It is a universal functional device that rehabilitates the position and the posture of all the components of the stomatognathic apparatus: tongue, hyoid bone, jaw, condyles, masticatory muscles, peripharyngeal muscles, mimic and facial skull-cervico-mandibular muscles.

These effects are increased and/or maximized in the specific aspect of the device as described in the following.

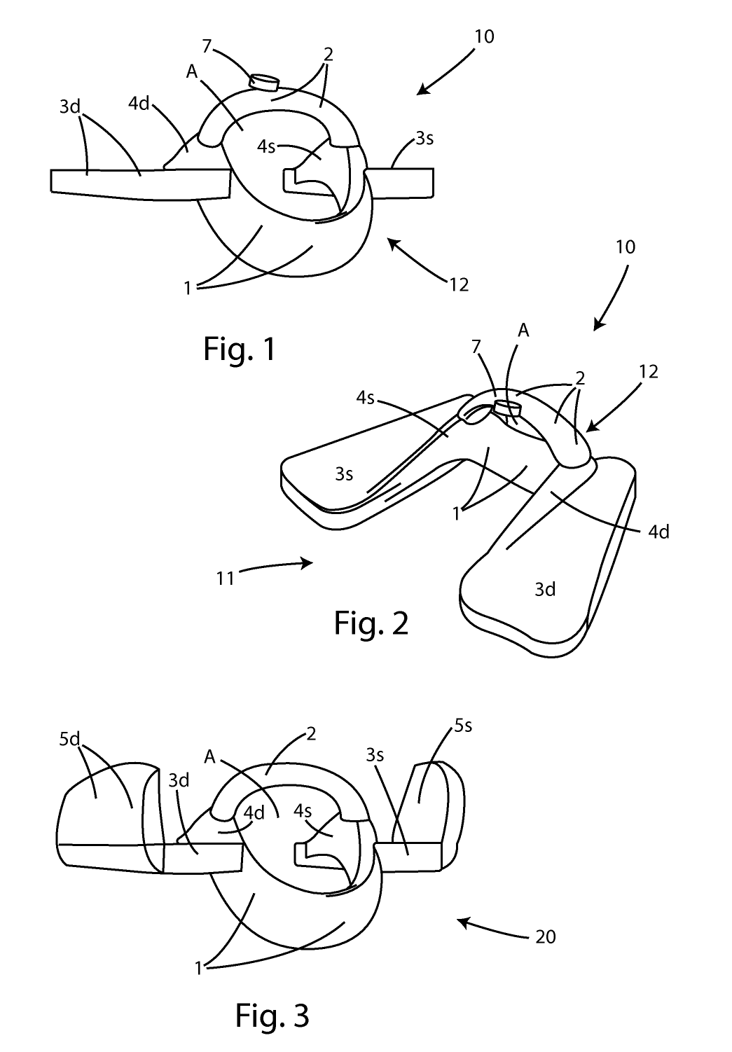

The device in FIGS. 1 and 2 is substantially in the basic configuration described above. An additional feature is the shapings 4s, 4d (vertical reinforcement edges) which extend from the surfaces 3s, 3d upwardly and possibly downwardly and are connected to the arcs 1 and 2. This is done to better accompany the tongue in its insertion. A second optional additional feature is constituted by at least one functional rehabilitation element 7, which can have the shape of a button or other forms (for example balls, spheres, rings) adapted to the size and morphology of the oral cavity as a function also of the rehabilitative action to be performed. The elements 7 may be placed at the middle of the upper arch 2, and may serve the functional rehabilitation of the tongue: speech, phoniatric, physio-, orthodontic therapy. They may have variable shape, design, location and angle, for example they can be balls, spheres, rings, holes, grids, shields, plans, buttons, rods, bands, strings, elastics, nets, guides, depending on the size and morphology of the oral cavity and the re-educational function to be performed.

In FIG. 3, a device 20 which is substantially based on the device of FIG. 2 is illustrated, wherein the so-called genial walls have been added on the left 5s and on the right 5d (in the specific re-presentation they have oval shape and are mirror-like with respect to the plane S). These walls are surfaces extending transversely and in particular, perpendicularly, to the surfaces 3s, 3d upwardly. The walls are adapted to contact the inside cheeks, and to balance the forces of the buccinatory muscles for better positioning the device 20.

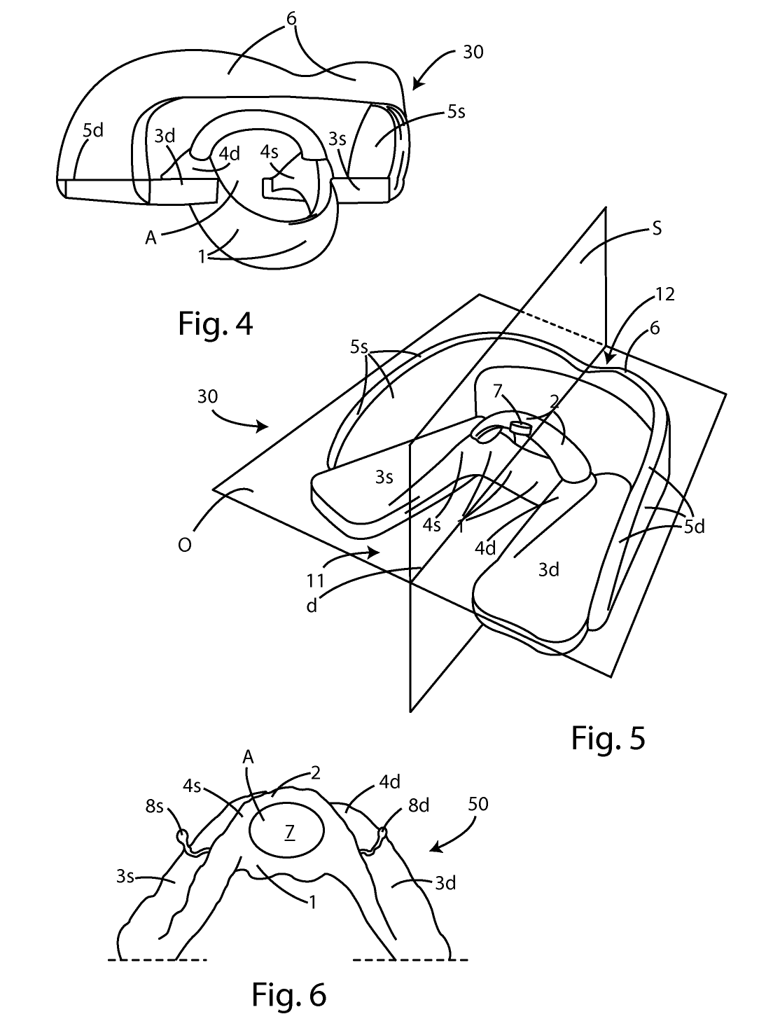

In FIGS. 4 and 5, a device 30 which is substantially based on the device of FIG. 3 is illustrated, in which the two genial surfaces 5d, 5s are connected upwards and towards the front side by a connecting front band 6, which in use will be placed so as to face the front dental elements, and in the front vestibular arches (between the upper teeth and upper lip).

FIG. 6 illustrates a device 50 wherein there are no more genial surfaces, but in their place, on the surfaces 3s, 3d, elements “8d” on the right and “8s” on the left have been fixed, which perform a function similar to that of the genial surfaces. These elements are plans, buttons, rods, guides, ball hooks, Adams clasps or orthodontic wires according to the size and morphology of the oral cavity, i.e. as a function of the action to be performed.

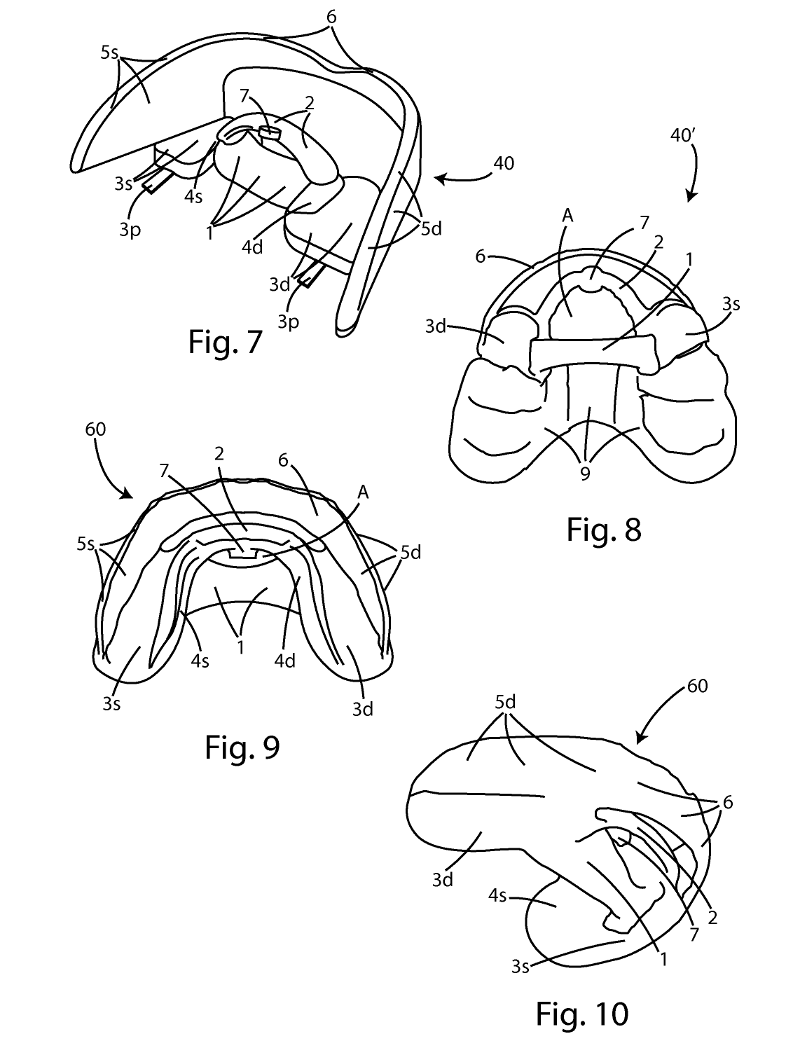

FIG. 7 shows a device 40 that has the structure similar to that of FIGS. 4 and 5, in which the surfaces 3s, 3d are of reduced size. This is because in such a way the device 40 is utilizable in the assembly 40′ of FIG. 8. In fact, it is simply to be introduced into a palatal plate 9 by one or more engagement elements which in FIG. 7 are represented by appropriate pins 3p.

FIGS. 9 and 10 show a device 60 substantially similar to that of FIGS. 4 and 5, in which the overall device is made in a single-shaped piece. In fact, the other exemplary devices can also be made in a single piece, or in several pieces, according to convenience of production or use.

The different parts of the devices described in the foregoing description may be such that the whole assembly or device is adapted to be built or printed in a standard mono-block made of various materials: plastic and/or non-toxic silicone, or realized in an individual way on models and plaster casts determined on the individual patient by the use of dental resins, with shapes, sizes, thickness, design, which can vary in relation to the size of the arches, the function, the dental class (I, II, III of Angle), or skeletal class, the age of subjects and the maxillofacial development or growth, or alternatively can be constituted by several parts of the same material which can be assembled, or, if useful for therapeutic purposes, of different materials.

In summary, the oral devices 10, 20, 30, 40, 40′, 50, 60 comprise first of all a first interocclusal surface 3s that can be inserted between the dental arches on the left and a second interocclusal surface 3d insertable between the dental arches on the right. These first and second interocclusal surfaces 3s, 3d are arranged substantially on a horizontal plane O and are mirror-like with respect to a sagittal plane S perpendicular to said horizontal plane O and passing between the two interocclusal surfaces 3s, 3d.

The oral device 10 extends along an extension direction d which is formed by the intersection between said horizontal plane O and said sagittal plane S and which goes from the back side 11 positioned in use between the molars of the dental arches to the front side 12 which in use is facing the canines and incisors.

The first interocclusal surface 3s and the second interocclusal surface 3d are joined by at least one upper arc 2 which in use extends above the horizontal plane O toward the palate and by at least one lower arc 1 which in use extends below the horizontal plane O towards the floor of the mouth. The at least one lower arc 1 and the at least one upper arc 2 form an opening A dimensioned in such a way to receive in use the tongue at least partially.

Some features that actively contribute to the effect of the therapeutic device relate to the inclination of the external and internal surface of said ring.

In particular, the at least one lower arc 1 lies on a plane “I” which forms with said horizontal plane “O” in the extension direction an acute angle γ (very interesting results have been found between 30 and 60° or between 35 and 45°), in such a way that the lower arc 1 extends towards said front side 12.

The lying plane of the lower arch can be drawn internally to said lower arc (i.e. touching the line that faces the horizontal plane) or along the side edges. It should be noted that the lying plane is inclined with respect to the plane of the surfaces that can be inserted between the dental arches. This holds true for the lying plane of the upper arch.

Furthermore, the at least one lower arc 1 has a lower arc section 1s on the sagittal plane S inclined so as to form an acute angle α with said direction of extension d. In particular, angle α may be between 30 and 55°, and more specifically, angle α may be between 35 and 45°.

Finally, the at least one upper arc 2 has an upper arc section 2s on the sagittal plane S inclined so as to form an acute angle β with said direction of extension d. In particular, angle β may be between 25 and 45°, and more specifically, angle β may be between 25 and 45°.

These angles can be calculated in various ways, preferably with respect to the line of the section that faces the horizontal plane O. In fact, it is the contact with the line that forces the tongue to rise. These section lines facing the horizontal plane can be straight or curved, but overall it is desirable that they show an inclination in order to push the tongue towards the palate.

Consequently, the tongue, which in use comes into the aperture A, is pushed towards the palate and forces lower incisors and jaw in a posture more advanced than they would have without the oral device, causing a change in the force vectors of masticatory muscles, in particular for the treatment of aforementioned skull-cervico-mandibular dysfunctions and annexed tissues.

The above-described device can be further improved with respect to the action of the buccinatory muscles, building it in such a way that on an edge of said first interocclusal surface 3s that, in use, faces a genial wall, a first genial surface 5s is connected which is substantially perpendicular to said first interocclusal surface 3s, so that, on an edge of said second interocclusal surface 3d that, in use, faces a genial wall, a second genial surface 5d is connected which is substantially perpendicular to said second interocclusal surface 3d. In such a way, said first surface 5s and said second genial surface 5d are arranged, in use, between the upper dental arch and the respective genial surfaces. Between said first 5s and said second genial surface 5d, a vestibular band 6 can be connected which runs substantially on said front side 12 and is adapted to be placed, in use, between the upper incisors and upper lip.

Although the device is autonomous, it can be inserted in a palate plate 9 realized starting from individual plaster casts.

To be able to decline further therapeutical properties of the device of the invention, one or more functional rehabilitative elements 7 are arranged in the vicinity of the top of said at least one upper arc 2, for examples buttons or rotating spheres.

In place of the genial surfaces, the device may have at least a first retaining element 8s fixed to said first surface 3s and at least one second retaining element 8d fixed to said second surface 3d.

For a better ergonomics of the device and its better positioning in the mouth, said first interocclusal surface 3s and said second interocclusal surface 3d have appropriate respective shapings 4s, 4d on the side facing the center of the mouth.

The device can thus assume an oblong shape (in extension direction d) or similar to a horseshoe with the ring that surrounds the soft parts of the tongue and the horizontal planes, the shields, and the front band that embrace other soft tissue and the teeth, in order to perform the stabilization function and allow the re-education and the positional disengagement of the teeth.

A device in the form of an irregular, funnel-shaped ring that surrounds the tongue is provided. According to one aspect of the invention, the device can be conveniently be constituted by three parts: A) a central part or the real lingual ring; B) an optional part of the systems of reinforcement, anchoring, balancing, connection and stabilization; C) an optional part of the rehabilitative functional reference systems. The device is a modifier of the vectors of the forces of the chewing muscles, that provides an active positional re-education of the anatomical and functional structures of the skull-cervical-mandibular unit and does not constitute a simple passive bearing which spaces apart the teeth, but a real universal functional device that re-educates the position and posture of all the components of the stomatognathic system: tongue, hyoid bone, jaw, condyles, masticatory muscles, peri-pharyngeal muscles, mimic facial muscles with associated skin tissues and skull-cervical-mandibular tissues.

In the foregoing, aspects of the invention have been described and variations of the invention have been suggested, but it is to be understood that those skilled in the art can make other variations and changes, without so departing from the related scope of protection, as defined by the appended claims.

What is claimed is:

1. Oral device, comprising:
a first interocclusal surface insertable between the left tooth arches,
a second interocclusal surface insertable between the right tooth arches,
said first and second interocclusal surfaces being disposed substantially on a horizontal plane and being specular with respect to a sagittal plane perpendicular to said horizontal plane and passing between the two interocclusal surfaces,
the oral device extending along an extension direction that is formed by the intersection between said horizontal plane and said sagittal plane and goes from the back side, that can be positioned in use between molar teeth of the tooth arches, to the front side, which in use is facing the canine teeth and incisors,
wherein:
said first interocclusal surface and said second interocclusal surface are united by at least an upper arch, which in use extends above said horizontal plane towards the palate, and at least a lower arch, which in use extends below said horizontal plane towards the mouth floor;
said at least a lower arch and said at least an upper arch forming an aperture dimensioned in such a way to receive in use at least partially the tongue;
said at least a lower arch lies on a plane forming with said horizontal plane in said extension direction an acute angle γ, in such a way that the lower arch extends towards said front side;
said at least a lower arch has a lower arch section on the sagittal plane inclined in such a way to form an acute angle α with said extension direction;
said at least un upper arch has an upper arch section, on the sagittal plane, inclined in such a way to form an acute angle β with said extension direction; and
so that, as a consequence, the tongue that in use enters said aperture is pushed towards the palate and compels the lower incisors and the mandible in a posture that is more advanced with respect to the posture without the oral device, causing a variation of vectors of forces of the masticatory muscles, in particular for the treatment of said skull-cervico-mandibular and relevant tissues dysfunctions.

2. The device according to claim 1, wherein said angle γ is comprised between 30 and 60°.

3. The device according to claim 2, wherein said angle γ is comprised between 35 and 45°.

4. The device according to any claim 1, wherein said acute angle α is comprised between 30 and 55°, in particular between 35 and 45°.

5. The device according to any claim 1, wherein said acute angle β is comprised between 25 and 45°, in particular between 30 and 40°.

6. The device according to any claim 1, wherein on an edge of said first interocclusal surface that, in use, faces a genial wall, a first genial surface is connected, which is substantially perpendicular to said first interocclusal surface, and in that on the edge of said second interocclusal surface that, in use, faces a genial wall, a second genial surface is connected, which is substantially perpendicular to said second interocclusal surface, in such a way that said first genial surface and said second genial surface are disposed, in use, between the upper tooth arch and the respective genial surfaces.

7. The device according to claim 6, wherein between said first and said second genial surface a vestibular band is connected, which runs substantially on said front side and is adapted to dispose, in use, between the upper incisors and the upper lip.

8. The device according to any claim 1, wherein said device is insertable in a palate plate realized starting from individual plaster cast.

9. The device according to any claim 1, wherein close to the top of said at least an upper arch one or more functional re-educative elements, in particular buttons or rotating spheres.

10. The device according to any claim 1, wherein it comprises at least a first retention element fixed to said first surface and at least a second retention element fixed to said second surface.

11. The device according to any claim 1, wherein said first interocclusal surface and said second interocclusal surface present suitable respective shapings on a side facing the center of the mouth.

12. The device according to any claim 1, wherein it is formed in an only piece.
